(19) United States
(12) Patent Application Publication
(10) Pub. No.: US 2021/0145694 A1
(43) Pub. Date: May 20, 2021

(54) Methods and System for Treatment of Skin Conditions Using Carbon Dioxide

(71) Applicants: Kyle Barker, Surrey (CA); Abid Shah, Burnaby (CA)

(72) Inventors: Kyle Barker, Surrey (CA); Abid Shah, Burnaby (CA)

(21) Appl. No.: 16/683,298

(22) Filed: Nov. 14, 2019

(51) Int. Cl. A61H 33/02; B01F 3/04

(52) U.S. Cl. CPC A61H 33/028; B01F 3/04248; A61H 2203/02; A61H 2201/5082; A61H 2201/5071

(57) ABSTRACT

The present invention discloses a therapeutic device includes a bubble generator configured to generate bubbles. The systems consists of a water pump, a diffuser to diffuse CO2 into the water, a sensor for temperature, a tank for CO2, a pressure regulator to lower the CO2 pressure from the tank, a solenoid valve to turn off and on the flow of CO2, a controller to control the system and a display to show the conditions of the system's operation.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to a therapeutic device to treat skin conditions, Description of the Related Art:

Eczema can be described as an inflammation of the skin where swelling, redness, itching or a burning sensation is present. Sometimes the first inflammation is felt, rather than seen, as it is immediately beneath the skin's surface. Eczema can also be seen as reddened spots, scales, crusts or blisters may also be present, either alone or in combination. It may take a mild form, or be more severe, as in the case of psoriasis.

Japanese Laid-Open Patent Publication Nos. 2008-296965 and 58-22555 disclose an example of a conventional cosmetic device. The cosmetic device of Publication No. 2008-296965 includes a container, a pump, and a mesh body. The pump mixes a liquid foaming agent stored in the container with air. When the gas and liquid mixture passes through the mesh body, bubbles are generated and sent to a brush. A user can supply the bubbles discharged from the brush of the cosmetic device to a target site such as a skin.

In U.S. Pat. Nos. 6,293,529 and 4,556,523, the micro bubbles could not practically or efficiently be used with typical fluid dispensing fittings such as hydrotherapy jets, shower heads, and liquid nozzles.

US-2015/0125400 discloses an example using a microfluidic based technique to produce microbubbles.

It is an objection of the present invention to provide a medicament to aid in the treatment and/or prophylaxis of eczema and psoriasis which will provide an alternative to existing treatments or to provide the public with a useful choice. None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is a method of treatment for eczema and/or psoriasis.

Another object of this invention is to provide product which is a fully automated method of diffusing CO2 into water in such a way that it will be attracted to user body via a negative electrical charge imparted onto it because of the relationship between surface tension and bubble size.

An additional object of the invention is that it sits on user bath tub for treating skin conditions. The systems consists of a water pump, a diffuser to diffuse CO2 into the water, a sensor for temperature, a tank for CO2, a pressure regulator to lower the CO2 pressure from the tank, a solenoid valve to turn off and on the flow of CO2, a controller to control the system and a display to show the conditions of the system's operation.

It is further object of the invention to provide an inexpensive system for this operation.

It is a further object of the present invention to provide a device that houses a diffuser having a porosity that allows CO2 to form bubbles on its surface that are in the range of, but not limited to, 50 to 75 microns in size or the size where the relationship to size and surface tension allows the bubble to hold a negative charge. This size accomplishes two things;

(1) the bubbles can stay in the water for up to two days,
(2) the size of the bubbles creates a negative charge on their surface because of the relationship between their size and surface tension.
This factor results in the benefit that the bubbles are attracted to user body when in the bath tub which allows this method to achieve resulting therapeutic levels while using approximately 1/1000″ the amount of gas as compared to other methods of Carbonic Therapy. The size of these bubbles is achieved by a relationship between the pore size of the diffuser and the internal gas pressure in relation to the external water pressure.

A therapeutic gadget as per one perspective incorporates a bubble generator designed to create bubbles, a restorative unit arranged to apply the corrective impact on the skin, and a motor arranged to drive in any event the corrective unit.

Still yet another object of the present invention is to provide a new and improved system which provides in the methods of the prior art some of the advantages thereof; while simultaneously overcoming some of the disadvantages normally associated therewith.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is an exemplary full view of the apparatus.

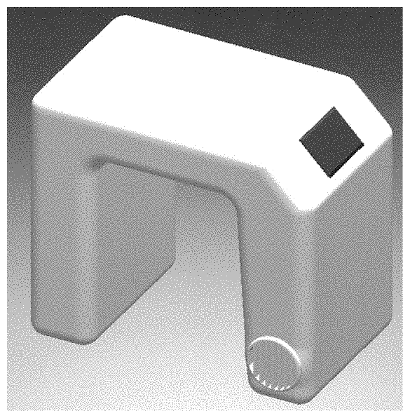

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to a therapeutic device to treat skin conditions.

As per preferred embodiment of the invention, the therapeutic device includes a bubble generator configured to generate bubbles. The systems consists of a water pump, a diffuser to diffuse CO2 into the water, a sensor for temperature, a tank for CO2, a pressure regulator to lower the CO2 pressure from the tank, a solenoid valve to turn off and on the flow of CO2, a controller to control the system and a display to show the conditions of the system's operation.

The invention may be operated continuously, thereby providing continuous-flow production of the bubbles in a straightforward manner.

The apparatus is relatively simple and hence may be manufactured in a straightforward manner and at low cost.

It will be appreciated that the invention above described fulfills the objectives and embodies the advantages over prior art structures as previously set forth above. The invention is not intended, however, to be limited to the specific details described and illustrated since changes apparent to those skilled in this art are contemplated.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: The systems consists of a water pump, a diffuser to diffuse CO2 into the water, a sensor for temperature, a tank for CO2, a pressure regulator to lower the CO2 pressure from the tank, a solenoid valve to turn off and on the flow of CO2, a controller to control the system and a display to show the conditions of the system's operation.

2: a bubble generator configured to generate bubbles.

3: A system which has been proven to reduce and control skin conditions such as Psoriasis and Eczema.
